(19) United States
(12) Patent Application Publication
(10) Pub. No.: US 2025/0137977 A1
(43) Pub. Date: May 1, 2025

(54) MEASURING SYSTEM, MEASURING METHOD AND TESTING METHOD

(71) Applicant: XMEMS TAIWAN CO., LTD., Hsinchu County (TW)

(72) Inventors: Yuan-Shuang Liu, Hsinchu County (TW); Ping-Sheng Wang, Hsinchu County (TW); Ming-che Chuang, Miaoli County (TW); Wei-Yang Li, Hsinchu County (TW); Kuan-Ju Tseng, Hsinchu City (TW)

(73) Assignee: XMEMS TAIWAN CO., LTD., Hsinchu County (TW)

(21) Appl. No.: 18/914,296

(22) Filed: Oct. 14, 2024

Related U.S. Application Data
(60) Provisional application No. 63/546,237, filed on Oct. 29, 2023.

(51) Int. Cl. G01N 29/44

(52) U.S. Cl. CPC G01N 29/4436; G01N 2291/102; G01N 2291/269

(57) ABSTRACT

A measuring system includes a first chamber, a sound sensing device, a sound source and a top cover. A first cavity exists inside the first chamber. The sound sensing device is configured to sense a sound in the first cavity. The sound source is configured to generate a sound wave propagating towards the first cavity. The top cover is disposed on the first chamber. The measuring system is configured to measure a degree of opening of a vent formed by a venting device. The venting device is disposed between the first chamber and the top cover and connected to the first cavity of the first chamber for being measured the degree of opening, the first cavity of the first chamber is between the venting device and the sound sensing device, and the degree of opening is obtained according to a result generated by the sound sensing device.

### CROSS REFERENCE TO RELATED APPLICATIONS

This application claims the benefit of U.S. Provisional Application No. 63/546,237, filed on Oct. 29, 2023. The content of the application is incorporated herein by reference.

### BACKGROUND OF THE INVENTION

### 1. FIELD OF THE INVENTION

The present application relates to a measuring system, a measuring method and a testing method, and more particularly, to a measuring system capable of measuring a degree of opening of a vent formed by a venting device, and to a related measuring method and a related testing method.

### 2. DESCRIPTION OF THE PRIOR ART

Nowadays, acoustic devices can be widely used in various electronic devices. In order to enhance the performance of the acoustic device, a venting device would be provided and be disposed in the acoustic device. For example, the venting device would be configured to suppress an occlusion effect during the operation of the acoustic device.

A degree of opening of a vent formed by the venting device is related to an effect of suppressing the occlusion effect. However, there is no instrument and system that measures the degree of opening of the vent of the venting device well at present. Thus, there is an urgent requirement for a system or an instrument which is capable of measuring the degree of opening of the vent of the venting device.

### SUMMARY OF THE INVENTION

It is therefore a primary objective of the present invention to provide a measuring system capable of using a sound sensing device to measure the degree of opening of the vent formed by the venting device. Furthermore, a related measuring method and a related testing method are provided in the present invention also.

An embodiment of the present invention provides a measuring system including a first chamber, a sound sensing device, a sound source and a top cover. A first cavity exists inside the first chamber. The sound sensing device is configured to sense a sound in the first cavity. The sound source is configured to generate a sound wave propagating towards the first cavity. The top cover is disposed on the first chamber. The measuring system is configured to measure a degree of opening of a vent formed by a venting device. The venting device is disposed between the first chamber and the top cover and connected to the first cavity of the first chamber for being measured the degree of opening, the first cavity of the first chamber is between the venting device and the sound sensing device, and the degree of opening is obtained according to a result generated by the sound sensing device.

Another embodiment of the present invention provides a measuring method. The measuring method includes: providing a measuring system; and performing a first measuring process on a venting device. The measuring system includes a first chamber, a sound source and a top cover, wherein a first cavity exists inside the first chamber, the sound source is configured to generate a sound wave propagating towards the first cavity, and the top cover is disposed on the first chamber. The first measuring process includes: disposing the venting device between the first chamber and the top cover; and sensing a first sound in the first cavity of the first chamber when generating the sound wave by the sound source, wherein a first degree of opening of a vent formed by the venting device is obtained according to a first result related to the first sound.

Another embodiment of the present invention provides a testing method of testing a venting device. The testing method includes: obtaining a reference result; obtaining a first result corresponding to a first mode of the venting device and a second result corresponding to a second mode of the venting device; obtaining a first difference between the first result and the reference result and a second difference between the second result and the reference result; determining the venting device under the first mode being normal when the first difference is less than a first value; and determining the venting device under the second mode being normal when the second difference is larger than a second value. The venting device is driven to operate in the first mode or the second mode. The second value is larger than the first value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a measuring system according to a first embodiment of the present invention.

FIG. 2 and FIG. 3 are schematic diagrams of cross sectional views illustrating a measuring system according to an exemplary example in the first embodiment of the present invention.

FIG. 4 is a schematic diagram illustrating a venting device according to an embodiment of the present invention.

FIG. 5 is a schematic diagram of cross sectional view illustrating the venting device in a first mode according to an embodiment of the present invention.

FIG. 6 is a schematic diagram of cross sectional view illustrating the venting device in a second mode according to an embodiment of the present invention.

FIG. 7 is a schematic diagram of cross sectional view illustrating the venting device in a third mode according to an embodiment of the present invention.

FIG. 8 is a schematic diagram illustrating a reference device according to an embodiment of the present invention.

FIG. 9 is a schematic diagram illustrating a flowchart of a measuring method according to an embodiment of the present invention.

FIG. 10 is a schematic diagram illustrating a measuring system according to a second embodiment of the present invention.

FIG. 11 is a schematic diagram illustrating a measuring system according to a third embodiment of the present invention.

FIG. 12 is a schematic diagram illustrating a measuring system according to a fourth embodiment of the present invention.

### DETAILED DESCRIPTION

To provide a better understanding of the present invention to those skilled in the art, preferred embodiments and typical material or range parameters for key components will be detailed in the follow description. These preferred embodiments of the present invention are illustrated in the accompanying drawings with numbered elements to elaborate on the contents and effects to be achieved. It should be noted that the drawings are simplified schematics, and the material and parameter ranges of key components are illustrative based on the present day technology, and therefore show only the components and combinations associated with the present invention, so as to provide a clearer description for the basic structure, implementing or operation method of the present invention. The components would be more complex in reality and the ranges of parameters or material used may evolve as technology progresses in the future. In addition, for ease of explanation, the components shown in the drawings may not represent their actual number, shape, and dimensions; details may be adjusted according to design requirements.

In the following description and in the claims, the terms “include”, “comprise” and “have” are used in an open-ended fashion, and thus should be interpreted to mean “include, but not limited to . . . ”. Thus, when the terms “include”, “comprise” and/or “have” are used in the description of the present invention, the corresponding features, areas, steps, operations and/or components would be pointed to existence, but not limited to the existence of one or a plurality of the corresponding features, areas, steps, operations and/or components.

In the following description and in the claims, when a component or layer is referred to as being “connected to” another component or layer, it can be directly connected to this another component or layer, or intervening components or layers may be presented. In contrast, when a component is referred to as being “directly connected to” another component or layer, there are no intervening components or layers presented.

In the following description and in the claims, when “a A1 component is formed by/of B1”, B1 exist in the formation of A1 component or B1 is used in the formation of A1 component, and the existence and use of one or a plurality of other features, areas, steps, operations and/or components are not excluded in the formation of A1 component.

In the following description and in the claims, the term “chamber” generally means an object having an empty space inside itself, and the term “cavity” means an empty space inside a chamber. That is to say, a cavity of a chamber is an empty space existing inside the chamber, and the chamber is a shell of the cavity.

In the following description and in the claims, the term “substantially” generally means a small deviation may exist or not exist. For instance, the terms “substantially parallel” and “substantially along” means that an angle between two components may be less than or equal to a certain degree threshold, e.g., 10 degrees, 5 degrees, 3 degrees or 1 degree. For instance, the term “substantially aligned” means that a deviation between two components may be less than or equal to a certain difference threshold, e.g., 2 μm or 1 μm. For instance, the term “substantially the same” means that a deviation is within, e.g., 10% of a given value or range, or mean within 5%, 3%, 2%, 1%, or 0.5% of a given value or range.

In the description and following claims, the term “horizontal direction” generally means a direction parallel to a horizontal plane, the term “horizontal plane” generally means a plane parallel to a direction X and a direction Y in the drawings (i.e., the direction X and the direction Y of the present invention may be considered as the horizontal directions), the term “vertical direction” and the term “top-view direction” generally mean a direction parallel to a direction Z and perpendicular to the horizontal direction in the drawings, and the direction X, the direction Y and the direction Z are perpendicular to each other. In the description and following claims, the term “top view” generally means a viewing result viewing along the vertical direction. In the description and following claims, the term “cross-sectional view” generally means a structure cut along the vertical direction is viewed along the horizontal direction.

Although terms such as first, second, third, etc., may be used to describe diverse constituent elements, such constituent elements are not limited by the terms. The terms are used only to discriminate a constituent element from other constituent elements in the specification, and the terms do not relate to the sequence of the manufacture if the specification do not describe. The claims may not use the same terms, but instead may use the terms first, second, third, etc. with respect to the order in which an element is claimed. Accordingly, in the following description, a first constituent element may be a second constituent element in a claim.

It should be noted that the technical features in different embodiments described in the following can be replaced, recombined, or mixed with one another to constitute another embodiment without departing from the spirit of the present invention.

In the present invention, a measuring system is configured to measure a venting device, so as to measure a degree of opening of a vent formed by the venting device (i.e., the measuring system is also referred as a vent measuring system). In some embodiments, the vent of the venting device may be controlled by electric signal(s). In some embodiments, the venting device may be disposed in an acoustic device, so as to enhance the performance of the acoustic device.

For example, the venting device may be disposed in the acoustic device (e.g., an in-ear earbud, an on-ear earphone or an over-ear earphone, etc.) configured to generate an acoustic wave, and the venting device may be configured to suppress an occlusion effect during the operation of the acoustic device, such that the experience of the user using the acoustic device is enhanced. The occlusion effect is due to the sealed volume of ear canal causing loud perceived sound pressure by the user (i.e., the listener). In some cases, the occlusion effect occurs while the user does specific motion(s) generating a bone-conducted sound (such as walking, jogging, talking, eating, touching the acoustic transducer, etc.) and uses the acoustic device filled in the user's ear canal, and the occlusion effect causes the user to hear the occlusion noise, thereby decreasing the listening quality of the user. Thus, because of the existence of the venting device, the volume of ear canal is not sealed when the vent of the venting device is opened, such that the occlusion effect may be suppressed, thereby enhancing the performance of the acoustic device and the experience of the user using the acoustic device.

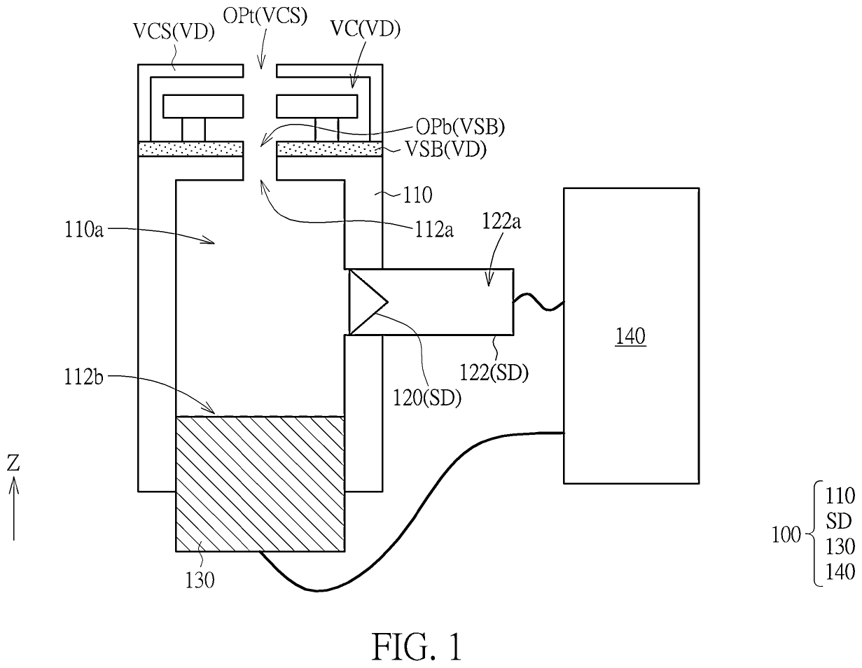

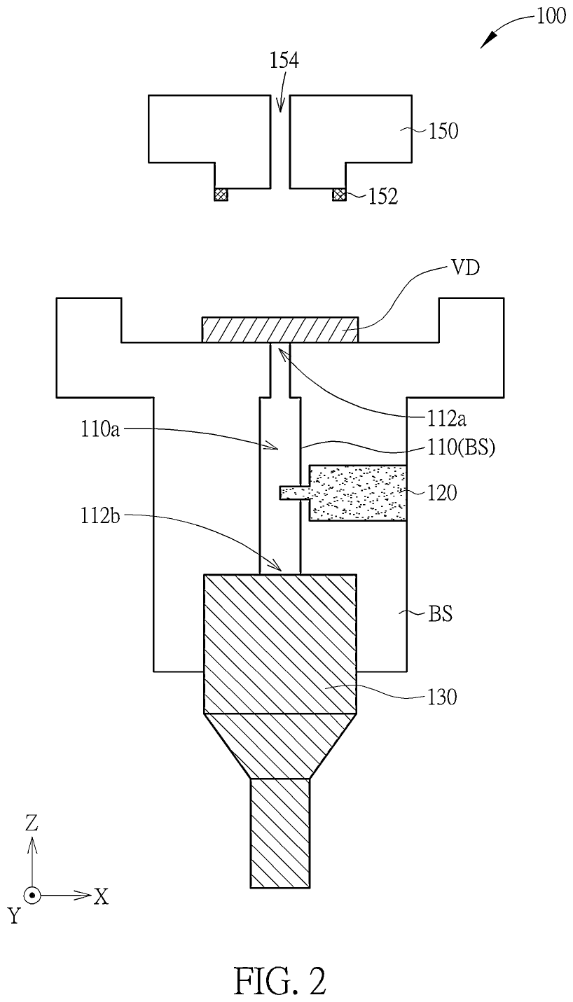

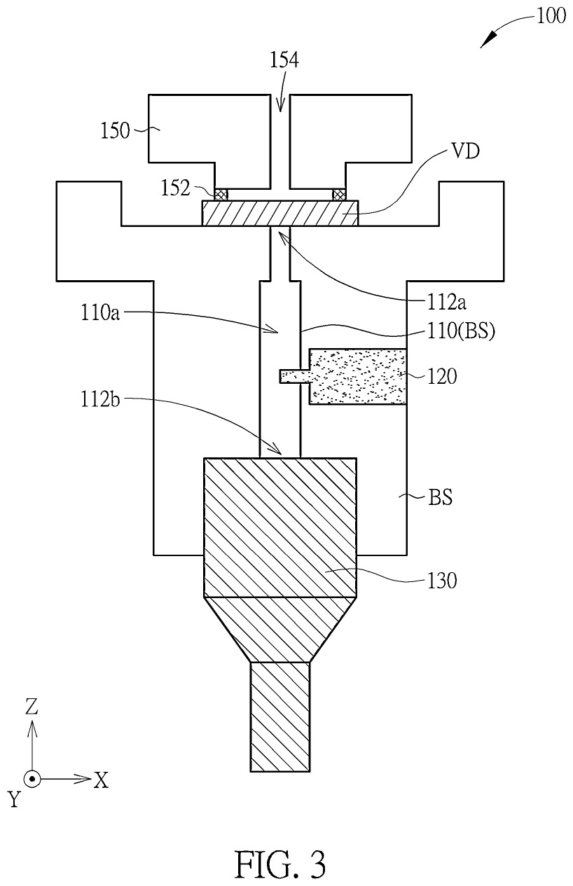

Referring to FIG. 1 to FIG. 3, FIG. 1 is a schematic diagram illustrating a measuring system according to a first embodiment of the present invention, and FIG. 2 and FIG. 3 are schematic diagrams of cross sectional views illustrating a measuring system according to an exemplary example in the first embodiment of the present invention. A structure shown in FIG. 1 is a first basic framework of a measuring system 100 of a first embodiment of the present invention, and the measuring system 100 of the first embodiment of the present invention may be achieved in any suitable way according to the first basic framework. Note that a structure shown in FIG. 2 and FIG. 3 is an exemplary example of the measuring system 100 of the first embodiment.

As shown in FIG. 1 to FIG. 3, the measuring system 100 includes a first chamber 110, and a first cavity 110a which is an empty space exists inside the first chamber 110. The first chamber 110 may be designed based on requirement(s). For example, in FIG. 1 to FIG. 3, the first chamber 110 may be a tubular structure extending along the direction Z, but not limited thereto. For example, the first chamber 110 may have one cross-sectional shape or a plurality of cross-sectional shapes, and the first chamber 110 may have one cross-sectional size or a plurality of cross-sectional sizes (e.g., in an example shown in FIG. 2 and FIG. 3, the first chamber 110 has a plurality of cross-sectional sizes).

In an exemplary example shown in FIG. 2 and FIG. 3, the measuring system 100 may include a blocky structure BS, wherein the first chamber 110 may belong to the blocky structure BS, such that an empty space in the blocky structure BS is the first cavity 110a of the first chamber 110, but not limited thereto.

In FIG. 1 to FIG. 3, the first chamber 110 may have at least one connecting opening configured to be connected between the first cavity 110a of the first chamber 110 and other component. The number of the connecting opening and the position of the connecting opening may be designed based on requirement(s). As shown in FIG. 1 to FIG. 3, the first chamber 110 has a first connecting opening 112a at least, and the first connecting opening 112a is configured to be connected between the first cavity 110a of the first chamber 110 and a device under test (e.g., the venting device VD). In FIG. 1 to FIG. 3, the first connecting opening 112a is situated at an end of the first chamber 110.

As shown in FIG. 1 to FIG. 3, the measuring system 100 includes a sound source 120 configured to generate a sound wave propagating towards the first cavity 110a of the first chamber 110, wherein the sound source 120 may be designed based on requirement(s). For example, the sound source 120 may be a speaker, but not limited thereto. In the present invention, the sound source 120 may be disposed at any suitable position. In some embodiments (as shown in FIG. 1), the sound source 120 may be disposed in the first cavity 110a of the first chamber 110, but not limited thereto. For example, in FIG. 1 to FIG. 3, the sound source 120 may be fixed by a sidewall of the first chamber 110 (e.g., in an exemplary example shown in FIG. 2 and FIG. 3, the sound source 120 may be disposed in the blocky structure BS, and a portion of the sound source 120 may be disposed in the first cavity 110a and fixed by a sidewall of the first chamber 110), but not limited thereto. In some embodiments (not shown in figures), the sound source 120 may be disposed outside the first chamber 110, and one connecting opening of the first chamber 110 may be connected to the sound source 120, such that the sound source 120 may generate the sound wave propagating towards the first cavity 110a through this connecting opening, but not limited thereto.

As shown in FIG. 1, a second chamber 122 may be further included in the measuring system 100 to enhance the function of the sound source 120 (e.g., enhance the sound pressure level of the sound wave), wherein a second cavity 122a which is an empty space exists inside the second chamber 122. In FIG. 1, the sound source 120 may be disposed between and connected between the second cavity 122a of the second chamber 122 and the first cavity 110a of the first chamber 110. In some embodiments, the sound source 120 and the second chamber 122 may be combined to be a sound generating device SD, but not limited thereto.

As shown in FIG. 1 to FIG. 3, the measuring system 100 includes a sound sensing device 130 configured to sense a sound in the first cavity 110a of the first chamber 110 and correspondingly generate a sensing signal, wherein the sound sensed by the sound sensing device 130 is caused by the sound source 120. For example, the sound sensing device 130 may sense the sound pressure level (SPL) of the sound in the first cavity 110a, but not limited thereto.

In FIG. 1 to FIG. 3, the first chamber 110 may further have a second connecting opening 112b, and the sound sensing device 130 may be connected to the first cavity 110a of the first chamber 110 through the second connecting opening 112b. In some embodiments (as shown in FIG. 1 to FIG. 3), the second connecting opening 112b may be situated at an end of the first chamber 110 and opposite to the first connecting opening 112a, such that the first cavity 110a of the first chamber 110 is between the device under test (e.g., the venting device VD) and the sound sensing device 130. For example, in FIG. 1 to FIG. 3, the sound sensing device 130 may face the device under test (e.g., the venting device VD), but not limited thereto. For example, in FIG. 1 to FIG. 3, the sound source 120 may be disposed between the device under test (e.g., the venting device VD) and the sound sensing device 130, but not limited thereto.

In the present invention, the measuring system 100 may further include a signal processing device 140 electrically connected to the sound sensing device 130, wherein the signal processing device 140 is configured to receive and analyze the sensing signal generated by the sound sensing device 130. Furthermore, in FIG. 1, the signal processing device 140 may also be electrically connected to the sound source 120, so as to provide an audio signal to the sound source 120 for controlling the sound wave generated by the sound source 120. Thus, the signal processing device 140 may control the sound wave generated by the sound source 120 and analyze the sensing signal generated by the sound sensing device 130 simultaneously. In some embodiments, the signal processing device 140 may include an amplifier, so as to enhance the signal strength.

As shown in FIG. 2 to FIG. 3, the measuring system 100 includes a top cover 150 disposed on the first chamber 110, so as to fix the device under test (e.g., the venting device VD). In FIG. 2 to FIG. 3, the top cover 150 is disposed on the device under test (e.g., the venting device VD), such that the device under test (e.g., the venting device VD) is disposed between the first chamber 110 and the top cover 150. Note that FIG. 1 does not show the top cover 150.

The top cover 150 may be designed based on requirement(s), and the top cover 150 may include any suitable material. For example, in FIG. 2 and FIG. 3, the top cover 150 may include a conductive structure 152 configured to be electrically connected to the device under test (e.g., the venting device VD).

As shown in FIG. 2 to FIG. 3, the top cover 150 may have an air channel 154, such that the air and/or the sound may pass through the top cover 150 through the air channel 154, wherein the air channel 154 may be designed based on requirement(s). For example, the air channel 154 may be a through hole, but not limited thereto. In this embodiment (as shown in FIG. 2 to FIG. 3), the air channel 154 may be connected to an outer space of the measuring system 100, and the air channel 154 may be connected to the first cavity 110a of the first chamber 110 through the device under test (e.g., the venting device VD), such that the first cavity 110a of the first chamber 110 may be connected to the outer space of the measuring system 100 through the air channel 154 and the device under test (e.g., the venting device VD).

In the present invention, the measuring system 100 may further include a position changing structure making the first chamber 110 and/or the top cover 150 move, such that the position changing structure may bring the first chamber 110 and the top cover 150 close to each other or away from each other. In FIG. 2, the first chamber 110 (i.e., the blocky structure BS) and the top cover 150 are away from and disconnected from each other, such that the device under test (e.g., the venting device VD) could be placed between the first chamber 110 (i.e., the blocky structure BS) and the top cover 150. In FIG. 3, the first chamber 110 (i.e., the blocky structure BS) and the top cover 150 are close to and connected to each other, such that the device under test (e.g., the venting device VD) is fixed by the top cover 150.

As shown in FIG. 1 to FIG. 3, the venting device VD which is the device under test is disposed between the first chamber 110 and the top cover 150, and the venting device VD is connected to the first cavity 110a of the first chamber 110 through the first connecting opening 112a. In some embodiments (as shown in FIG. 1), the venting device VD may be a package structure packaging a venting component VC, wherein the venting component VC may be designed based on requirement(s). For instance, the venting component VC may be a MEMS (Micro Electro Mechanical System) component, but not limited thereto.

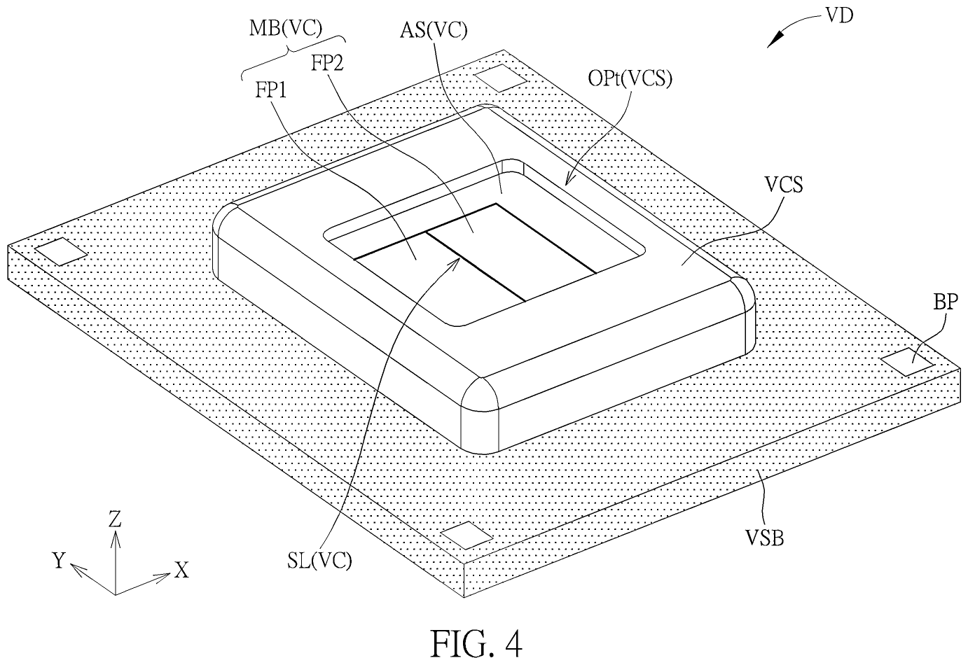

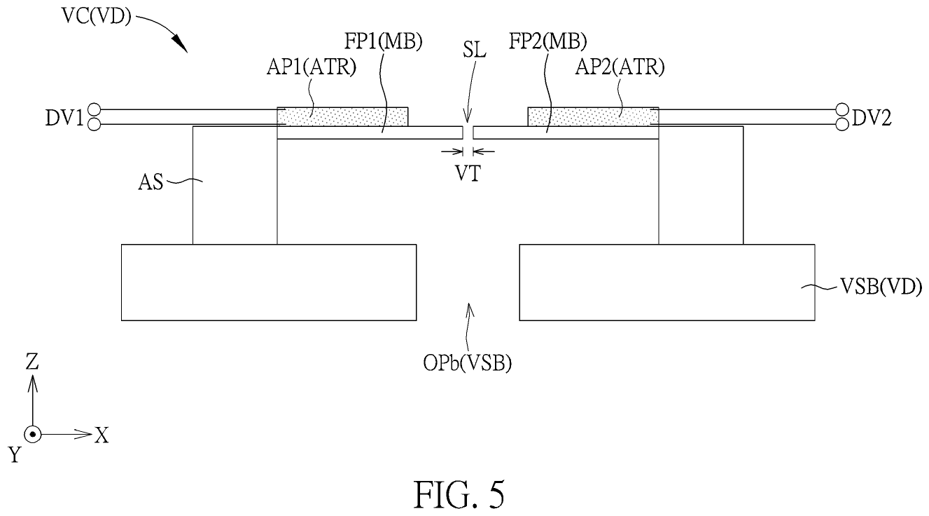

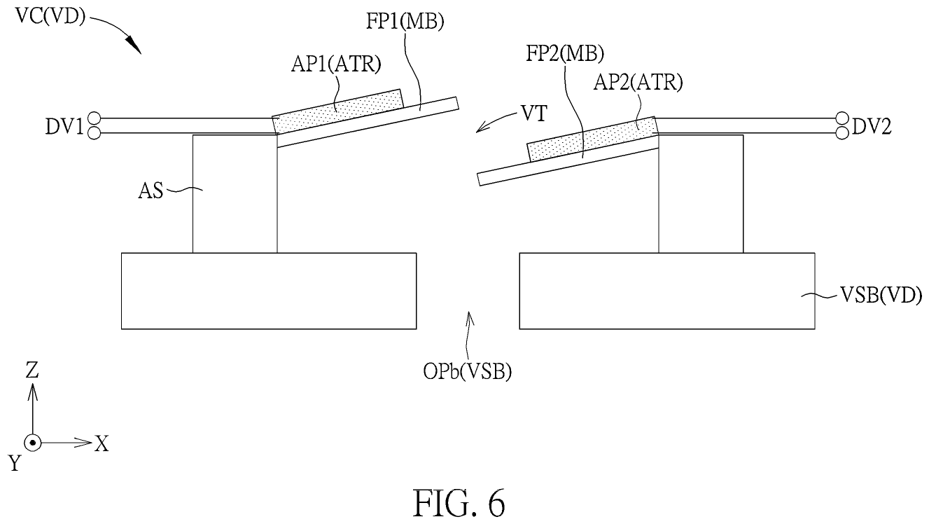

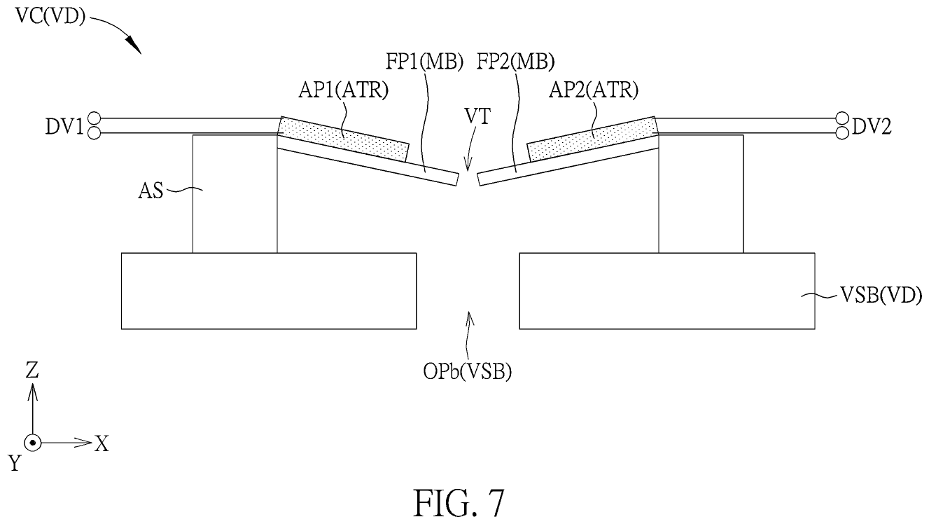

The detail of the venting device VD is described in the following, and FIG. 4 to FIG. 7 are further referred. FIG. 4 is a schematic diagram illustrating a venting device VD according to an embodiment of the present invention, FIG. 5 is a schematic diagram of cross sectional view illustrating the venting device VD in a first mode according to an embodiment of the present invention, FIG. 6 is a schematic diagram of cross sectional view illustrating the venting device VD in a second mode according to an embodiment of the present invention, and FIG. 7 is a schematic diagram of cross sectional view illustrating the venting device VD in a third mode according to an embodiment of the present invention.

As shown in FIG. 1 and FIG. 4, the venting device VD further includes a substrate VSB and a covering structure VCS disposed on the substrate VSB, wherein the venting component VC is disposed between the substrate VSB and the covering structure VCS. In FIG. 1 and FIG. 4, the venting component VC and the covering structure VCS may be disposed on a first side of the substrate VSB, the first chamber 110 is situated on a second side of the substrate VSB, and the first side is opposite to the second side (i.e., the substrate VSB is between the first chamber 110 and the venting component VC) in the direction Z, but not limited thereto.

As shown in FIG. 1 and FIG. 4, the covering structure VCS has a top opening OPt, and the substrate VSB has a bottom opening OPb. In some embodiments, as shown in FIG. 1 and FIG. 4, the top opening OPt of the covering structure VCS, the bottom opening OPb of the substrate VSB and the first connecting opening 112a of the first chamber 110 may be corresponding to each other in the direction Z.

The substrate VSB may be designed based on requirement(s). The substrate VSB may be hard or flexible, wherein the substrate VSB may include silicon, germanium, glass, plastic, quartz, sapphire, metal, polymer (e.g., polyimide (PI), polyethylene terephthalate (PET)), any other suitable material or a combination thereof. As an example, the substrate VSB may be a circuit board including a laminate (e.g., copper clad laminate, CCL), a land grid array (LGA) board or any other suitable board containing conductive material, but not limited thereto. In FIG. 1 and FIG. 4, a normal direction of the substrate VSB may be parallel to the direction Z.

As shown in FIG. 4, the substrate VSB has at least one substrate conductive structure. For example, the substrate VSB has a plurality of conductive pads BP configured to be electrically connected to the venting component VC, but not limited thereto. For example, in FIG. 4, the conductive pad BP, the covering structure VCS and the venting component VC may be disposed on the same side of the substrate VSB, but not limited thereto.

The covering structure VCS may be designed based on requirement(s). In the present invention, the covering structure VCS may be a one-piece structure (as shown in FIG. 4) or be composed of a plurality of sub-structures. The covering structure VCS may include any suitable material, such as metal, glass, silicon, germanium, plastic, polymer or a combination thereof, but not limited thereto.

As shown in FIG. 1 and FIG. 4 to FIG. 7, the venting component VC includes an anchor structure AS, a membrane MB anchored by the anchor structure AS and an actuator ATR configured to actuate the membrane MB. In some embodiments, the anchor structure AS may be disposed outside the membrane MB, and the actuator ATR is disposed on the membrane MB.

The membrane MB and the anchor structure AS may include any suitable material(s). In some embodiments, the membrane MB and the anchor structure AS may individually include silicon (e.g., single crystalline silicon or poly-crystalline silicon), silicon compound (e.g., silicon carbide, silicon oxide), germanium, germanium compound (e.g., gallium nitride or gallium arsenide), gallium, gallium compound, stainless steel or a combination thereof, but not limited thereto. In some embodiments, the membrane MB and the anchor structure AS may have the same material.

In the operation of the venting component VC, the membrane MB may be actuated to have a movement, and the anchor structure AS may be immobilized. Namely, the anchor structure AS may be a fixed end (or fixed edge) respecting the membrane MB during the operation of the venting component VC. In some embodiments, the membrane MB may be actuated to move upwards and downwards, wherein the terms “move upwards” and “move downwards” represent that the membrane MB moves substantially along the normal direction of the substrate VSB (e.g., in FIG. 1 and FIG. 4 to FIG. 7, the membrane MB moves substantially along the direction Z).

In FIG. 4 to FIG. 7, the membrane MB includes a plurality of flaps divided by at least one slit SL, and the vent VT is formed because of the slit SL, wherein the flaps may be actuated to move in the direction Z, so as to change the size (i.e., the degree of opening) of the vent VT. For example, in FIG. 4 to FIG. 7, the membrane MB may include a first flap FPI and a second flap FP2, and the first flap FP1 and the second flap FP2 may be divided by one slit SL, but not limited thereto. Note that the slit SL has a sufficiently small width to be a narrow slit.

As shown in FIG. 5 to FIG. 7, the actuator ATR may include a plurality of actuating portions disposed on the flaps of the membrane MB. For instance (as shown in FIG. 5 to FIG. 7), since the membrane MB includes the first flap FP1 and the second flap FP2, the actuator ATR includes a first actuating portion AP1 disposed on the first flap FP1 and a second actuating portion AP2 disposed on the second flap FP2.

The actuator ATR has a monotonic electromechanical converting function with respect to the movement of the membrane MB along the direction Z. In some embodiments, the actuator ATR may include actuator, a piezoelectric an electrostatic actuator, a nanoscopic-electrostatic-drive (NED) actuator, an electromagnetic actuator or any other suitable actuator, but not limited thereto. For example, in an embodiment, the actuator ATR may include a piezoelectric actuator, the piezoelectric actuator may contain such as two electrodes and a piezoelectric material layer (e.g., lead zirconate titanate, PZT) disposed between the electrodes, wherein the piezoelectric material layer may actuate the membrane MB based on driving signals (e.g., driving voltages and/or driving voltage difference between two electrodes) received by the electrodes, but not limited thereto. For example, in another embodiment, the actuator ATR may include an electromagnetic actuator (such as a planar coil), wherein the electromagnetic actuator may actuate the membrane MB based on a received driving signals (e.g., driving current) and a magnetic field (i.e. the membrane MB may be actuated by the electromagnetic force), but not limited thereto. For example, in still another embodiment, the actuator ATR may include an electrostatic actuator (such as conducting plate) or a NED actuator, wherein the electrostatic actuator or the NED actuator may actuate the membrane MB based on a received driving signals (e.g., driving voltage) and an electrostatic field (i.e. the membrane MB may be actuated by the electrostatic force), but not limited thereto. In the following, the actuator ATR may be a piezoelectric actuator for example.

In some embodiments, the venting device VD may have a plurality of modes according to the positions of flap of the membrane MB of the venting component VC. The vent VT has different sizes (i.e., different degrees of opening) in different modes.

In FIG. 5, when the venting device VD in a first mode, the first flap FP1 and the second flap FP2 may be actuated and maintained as a first position, so as to make the vent VT have a first size (i.e., a first degree of opening). In some embodiments, the first position may be parallel to the substrate VSB, such that the vent VT is closed, but not limited thereto. In the first mode, since the slit SL is a narrow slit and has a sufficiently small width, the airflow through the slit SL (or the vent VT) would be highly damped due to viscous forces/resistance along the walls of the airflow pathways, known as boundary layer effect within field of fluid mechanics. Accordingly, the airflow flowing through the slit SL (or the vent VT) in the first mode is significantly small or negligible. In other words, when the venting device VD is in the first mode, the vent VT is closed and almost sealed.

In FIG. 6, when the venting device VD in a second mode, the first flap FP1 and the second flap FP2 may be actuated to move along opposite directions, such that the vent VT is opened and has a second size (i.e., a second degree of opening). In a first type of the second mode (as shown in FIG. 6), in the direction Z, the first flap FP1 is upper than the first position, and the second flap FP2 is lower than the first position. In a second type of the second mode (not shown in figures), in the direction Z, the first flap FP1 is lower than the first position, and the second flap FP2 is upper than the first position. In the present invention, the first size of the vent VT in the first mode is different from the second size of the vent VT in the second mode. In FIG. 5 and FIG. 6, the first size of the vent VT in the first mode is smaller than the second size of the vent VT in the second mode.

Optionally, the venting device VD may have a third mode. In FIG. 7, when the venting device VD in the third mode, the first flap FPI and the second flap FP2 may be actuated to lower than the first position in the direction Z, so as to make the vent VT have a third size (i.e., a third degree of opening). In some embodiments, the first flap FP1 and the second flap FP2 are close to the substrate VSB. In the present invention, the third size of the vent VT in the third mode is different from the first size of the vent VT in the first mode and the second size of the vent VT in the second mode. In FIG. 5 to FIG. 7, the first size of the vent VT in the first mode is smaller than the third size of the vent VT in the third mode, and the third size of the vent VT in the third mode is smaller than the second size of the vent VT in the second mode. For instance, the vent VT is almost closed when the venting device VD is in the third mode, but not limited thereto.

The mode of the venting device VD may be controlled by the actuating signal (i.e., the electric signal) applied on the actuator ATR. In some embodiments, the actuating signal may be applied on the actuator ATR through the conductive pad BP of the substrate VSB (e.g., the actuating signal may be applied on the actuator ATR through an electrical path formed of the conductive structure 152 of the top cover 150 and the conductive pad BP of the substrate VSB). For example, as shown in FIG. 5, the actuating signals DV1 and DV2 respectively actuating the first flap FP1 and the second flap FP2 may be 15V in the first mode, but not limited thereto. For example, the actuating signal DV1 actuating the first flap FP1 may be 30V and the actuating signal DV2 actuating the second flap FP2 may be 0V in the first type of the second mode (as shown in FIG. 6), and the actuating signal DV1 actuating the first flap FP1 may be 0V and the actuating signal DV2 actuating the second flap FP2 may be 30V in the second type of the second mode (not shown in figures), but not limited thereto. For example, as shown in FIG. 7, the actuating signals DV1 and DV2 respectively actuating the first flap FP1 and the second flap FP2 may be 0V in the third mode, but not limited thereto.

In the present invention, the measuring system 100 may further include a mode changing device configured to control the mode of the venting device VD (e.g., the actuating signals DV1 and DV2 applied on the actuator ATR are provided from the mode changing device). In some embodiments, the mode changing device is electrically connected to the venting device VD through the conductive structure 152 of the top cover 150 and the conductive pads BP of the substrate VSB, but not limited thereto. In some embodiments, the mode changing device may be integrated in the signal processing device 140, but not limited thereto.

In the present invention, the measuring system 100 is configured to measure the degree of opening of the vent VT formed by the venting device VD. In this embodiment, since the venting device VD has three modes, the measuring system 100 would measure the first degree of opening of the vent VT in the first mode, the second degree of opening of the vent VT in the second mode and the third degree of opening of the vent VT in the third mode.

In the measuring system 100 shown in FIG. 1 to FIG. 3, the top cover 150 has an air channel 154 connected to the outer space of the measuring system 100, such that the first cavity 110a of the first chamber 110 is connected to the outer space of the measuring system 100 through the air channel 154 and the venting device VD. According to the design of the measuring system 100 shown in FIG. 1 to FIG. 3, since the sound source 120 generates the sound wave in the first cavity 110a and between the venting device VD and the sound sensing device 130, the amount of the air leakage and/or the amount of the sound leakage leaked between the first cavity 110a and the outer space of the measuring system 100 is changed because of the degree of opening of the vent VT (i.e., the size of the vent VT) formed by the venting device VD (i.e., the amount of the air leakage and the amount of the sound leakage are enhanced as the degree of opening of the vent VT is enlarged), such that the performance of the sound in the first cavity 110a is correspondingly changed also. Thus, the sound sensing device 130 of the measuring system 100 is used to sense the sound in the first cavity 110a, so as to measure the degree of opening of the vent VT formed by the venting device VD.

Accordingly, when the venting device VD operates in the first mode, the sound sensing device 130 sense a first sound in the first cavity 110a of the first chamber 110 to obtain a first result (e.g., a first sensing signal) related to the first sound, such that the first degree of opening of the vent VT formed by the venting device VD in the first mode is obtained according to the first result. When the venting device VD operates in the second mode, the sound sensing device 130 sense a second sound in the first cavity 110a of the first chamber 110 to obtain a second result (e.g., a second sensing signal) related to the second sound, such that the second degree of opening of the vent VT formed by the venting device VD in the second mode is obtained according to the second result. When the venting device VD operates in the third mode, the sound sensing device 130 sense a third sound in the first cavity 110a of the first chamber 110 to obtain a third result (e.g., a third sensing signal) related to the third sound, such that the third degree of opening of the vent VT formed by the venting device VD in the third mode is obtained according to the third result.

In some embodiments, the sound pressure level of the sound in the first cavity 110a is changed because of the air leakage and/or the sound leakage, and the influence of the sound pressure level of the sound in the first cavity 110a is enhanced as the degree of opening of the vent VT is enlarged. Thus, the sound sensing device 130 may sense the sound pressure level of the sound in the first cavity 110a, so as to measure the degree of opening of the vent VT formed by the venting device VD.

For instance, the sound source 120 may generate a sound wave with a plurality of frequencies, and the sound sensing device 130 may sense the sound in the first cavity 110a to obtain a frequency response of this measuring system 100 (i.e., the first result, the second result and the third result are frequency responses in different modes), wherein the frequency response is a relation between the sound pressure level and the frequency. In the frequency response of this measuring system 100, a low frequency roll-off (LFRO) would occur due to the air leakage and/or the sound leakage caused by the vent VT, and a degree of the LFRO is increased as the degree of opening of the vent VT is enlarged. Thus, the degree of opening of the vent VT may be known by measuring the degree of the LFRO. In this case, the degree of the LFRO in the first result is less than the degree of the LFRO in the third result, and the degree of the LFRO in the third result is less than the degree of the LFRO in the second result.

For instance, the sound source 120 may generate a sound wave with one suitable frequency, and the sound sensing device 130 may sense the sound pressure level of the sound in the first cavity 110a (i.e., the first result, the second result and the third result are sound pressure levels in different modes). Due to the air leakage and/or the sound leakage, the change degree of the sound pressure level of the sound is increased as the degree of opening of the vent VT is enlarged (e.g., the sound pressure level of the sound is decreased as the degree of opening of the vent VT is enlarged). Thus, the degree of opening of the vent VT may be known by measuring the sound pressure level of the sound in the first cavity 110a. In this case, the sensed sound pressure level in the first result is greater than the sensed sound pressure level in the third result, and the sensed sound pressure level in the third result is greater than the sensed sound pressure level in the second result. For example, the LFRO would occur when the sound source 120 generates the sound wave with this suitable frequency, such that the sensed sound pressure level is decreased as the degree of opening of the vent VT is enlarged, but not limited thereto. For example, the frequency of the sound wave may be approximately 100 Hz, but not limited thereto.

According to above measurement, in order to accurately measure the degree of opening of the vent VT formed by the venting device VD, a reference device is provided, wherein the measuring system 100 would measure a degree of opening of the reference device to obtain a reference result (e.g., a reference sensing signal) generated by the sound sensing device 130, and the reference result is a baseline for comparing with the result obtaining in the measurement of the venting device VD.

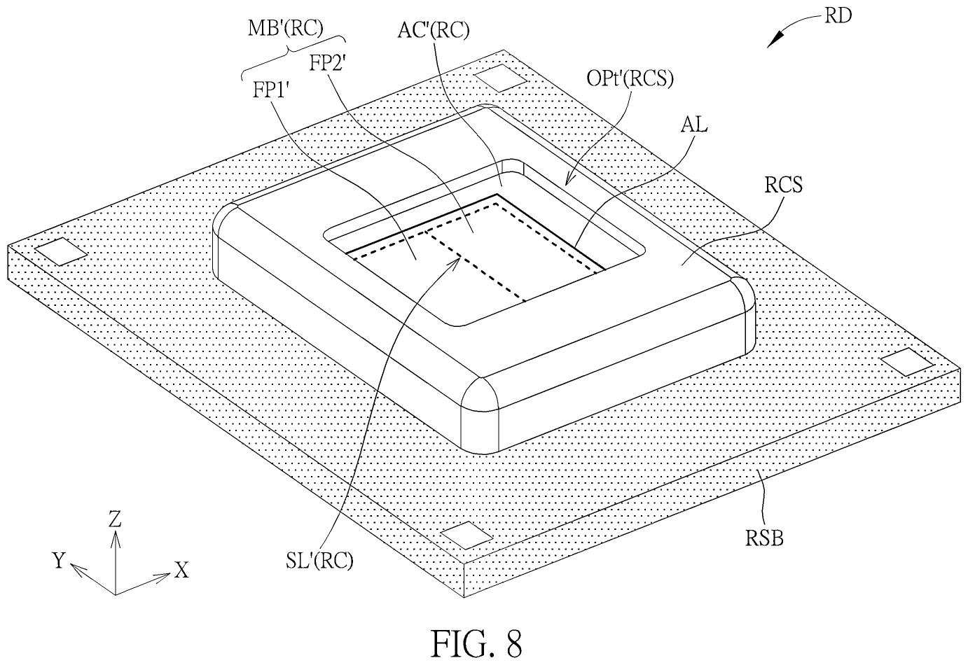

The reference device may be designed based on requirement(s). In some embodiments, the reference device is a fully sealed device, such that the reference device has a minimum degree of opening. Referring to FIG. 8, FIG. 8 is a schematic diagram illustrating a reference device according to an embodiment of the present invention. For example, as shown in FIG. 8, the reference device RD is extremely similar to the venting device VD, but the slit SL′ (i.e., the vent VT) is sealed by an adhering material AL. Namely, the reference device RD includes a reference substrate RSB, a reference covering structure RCS disposed on the reference substrate RSB and a reference component RC disposed between the reference substrate RSB and the reference covering structure RCS. The reference substrate RSB has a bottom opening and the same as the substrate VSB of the venting device VD. The reference covering structure RCS has a top opening OPt′ and the same as the covering structure VCS of the venting device VD. The reference component RC is extremely similar to the venting component VC, and the reference component RC includes an anchor structure AS′, a membrane MB′ anchored by the anchor structure AS′ and an actuator disposed on the membrane MB′, wherein the membrane MB′ has a plurality of flaps (e.g., a first flap FP1′ and a second flap FP2′) and a slit SL′ dividing the flaps, but the slit SL′ (i.e., a vent of reference device RD) is sealed by the adhering material AL.

Since the reference device RD is a fully sealed device, the reference device RD would almost never cause the air leakage and the sound leakage. Therefore, a difference between the result of measuring the venting device VD and the reference result of measuring the reference device RD is decreased as a difference of the degree of opening of the vent VT formed by the venting device VD and the degree of opening of the reference device RD is decreased. Namely, the venting device VD is designed to achieve that a difference between the result of measuring the venting device VD and the reference result of measuring the reference device RD is extremely small (e.g., this difference is smaller than a specific small value) if the vent VT of the venting device VD is closed, and the venting device VD is designed to achieve that a difference between the result of measuring the venting device VD and the reference result of measuring the reference device RD is large (e.g., this difference is greater than a specific large value) if the vent VT of the venting device VD is opened.

In some embodiments, in the condition that the sound source 120 generates the sound wave with one suitable frequency (e.g., 100 Hz), a first difference between the sensed sound pressure level in the first result (i.e., the first mode) and the sensed sound pressure level in the reference result may be less than or equal to a first value. For example, the first value may be 1 dB, such that the first difference may range from 0 dB to 1 dB, but not limited thereto. For example, the venting device VD under the first mode is determined to be normal when the first difference is less than or equal to the first value.

In some embodiments, in the condition that the sound source 120 generates the sound wave with one suitable frequency (e.g., 100 Hz), a second difference may be between the sensed sound pressure level in the second result (i.e., the second mode) and the sensed sound pressure level in the reference result or may be between the sensed sound pressure level in the second result (i.e., the second mode) and the sensed sound pressure level in the first result (i.e., the first mode), and the second difference may be greater than or equal to a second value, wherein the second value is greater than the first value. For example, the second value may be 20 dB (e.g., the second difference may range from 23 dB to 27 dB), but not limited thereto. For example, the venting device VD under the second mode is determined to be normal when the second difference is greater than or equal to the second value.

In some embodiments, in the condition that the sound source 120 generates the sound wave with one suitable frequency (e.g., 100 Hz), a third difference between the sensed sound pressure level in the third result (i.e., the third mode) and the sensed sound pressure level in the reference result may be a third value approximately or in a range of which the third value is an average, wherein the third value is between the first value and the second value (i.e., the third value is greater than the first value and less than the second value), and a difference between the third value and the first value is less than a difference between the third value and the second value. In another embodiment, the venting device VD under the third mode is determined to be normal when the third difference is less than or equal to the third value. For example, the third value may be 5 dB (e.g., the third difference may range from 3 dB to 7 dB), but not limited thereto.

Furthermore, the degree of the LFRO in the condition of measuring the reference device RD is lower than the degree of the LFRO in the condition of measuring the venting device VD in each mode, and the sensed sound pressure level in the condition of measuring the reference device RD is greater than the sensed sound pressure level in the condition of measuring the venting device VD in each mode.

In the following, the details of a measuring method will be further exemplarily explained. Note that the measuring method of the present invention is also referred as a vent measuring method.

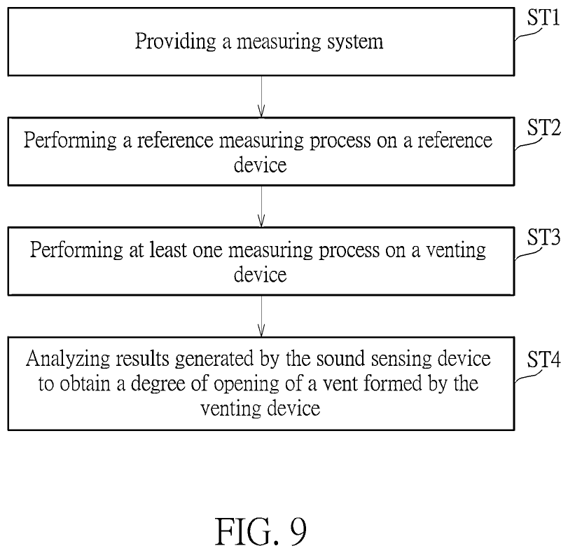

Referring to FIG. 9, FIG. 9 is a schematic diagram illustrating a flowchart of a measuring method according to an embodiment of the present invention. It is to be appreciated that the flowchart shown in FIG. 9 is exemplary. In some embodiments, some of the steps may be performed simultaneously, or in a different order than shown in FIG. 9. In some embodiments, before or after one of the existing steps of the measuring method shown in FIG. 9, any other suitable step may be added. Regarding the following contents, the measuring method shall be described with reference to FIG. 9. However, the measuring method is not limited by the following embodiment.

In the step ST1 of FIG. 9, the measuring system 100 is provided, wherein the measuring system 100 is described in the above, and these contents will not be redundantly described.

In the step ST2 of FIG. 9, a reference measuring process is performed on the reference device RD. The reference device RD is described in the above, and these contents will not be redundantly described.

In the reference measuring process, the reference device RD is disposed between the first chamber 110 and the top cover 150. For example, in the measuring system 100 shown in FIG. 2 and FIG. 3, the first chamber 110 and the top cover 150 are close to each other after the reference device RD is disposed between the first chamber 110 and the top cover 150. Then, the reference sound in the first cavity 110a of the first chamber 110 is sensed by the sound sensing device 130 when generating the sound wave by the sound source 120, so as to obtain the reference result generated by the sound sensing device 130 and related to the reference sound.

Furthermore, a calibrating process applied on the sound source 120 may be performed, such that the sound source 120 provides the required sound wave with suitable frequency. For example, the calibrating process and the reference measuring process may be performed simultaneously, but not limited thereto. For example, the calibrating process is performed before performing the reference measuring process, but not limited thereto.

In the step ST3 of FIG. 9, at least one measuring process is performed on the venting device VD. The venting device VD is described in the above, and these contents will not be redundantly described. Since the venting device VD has the first mode, the second mode and the third mode, a first measuring process is performed on the venting device VD in the first mode, a second measuring process is performed on the venting device VD in the second mode, and a third measuring process is performed on the venting device VD in the third mode.

In the first measuring process, the venting device VD in the first mode is disposed between the first chamber 110 and the top cover 150. For example, in the measuring system 100 shown in FIG. 2 and FIG. 3, the first chamber 110 and the top cover 150 are close to each other after the venting device VD is disposed between the first chamber 110 and the top cover 150. Then, the first sound in the first cavity 110a of the first chamber 110 is sensed by the sound sensing device 130 when generating the sound wave by the sound source 120, so as to obtain the first result generated by the sound sensing device 130 and related to the first sound.

In the second measuring process, the venting device VD in the second mode is disposed between the first chamber 110 and the top cover 150. Then, the second sound in the first cavity 110a of the first chamber 110 is sensed by the sound sensing device 130 when generating the sound wave by the sound source 120, so as to obtain the second result generated by the sound sensing device 130 and related to the second sound. In this embodiment, both the venting device VD in the first type of the second mode and the venting device VD in the second type of the second mode are measured in the second measuring process, so as to obtain two second results.

In the third measuring process, the venting device VD in the third mode is disposed between the first chamber 110 and the top cover 150. Then, the third sound in the first cavity 110a of the first chamber 110 is sensed by the sound sensing device 130 when generating the sound wave by the sound source 120, so as to obtain the third result generated by the sound sensing device 130 and related to the third sound.

Note that the mode of the venting device VD is controlled by the mode changing device in the measuring method.

In the step ST4 of FIG. 9, the results generated by the sound sensing device 130 are analyzed to obtain the degree of opening of the vent VT formed by the venting device VD. The first degree of opening of the vent VT formed by the venting device VD in the first mode is obtained according to the first result related to the first sound and the reference result related to the reference sound. The second degree of opening of the vent VT formed by the venting device VD in the second mode is obtained according to the second result related to the second sound and the reference result related to the reference sound, or according to the second result related to the second sound and the first result related to the first sound. The third degree of opening of the vent VT formed by the venting device VD in the third mode is obtained according to the third result related to the third sound and the reference result related to the reference sound.

In some embodiments, the first degree of opening of the vent VT in the first mode may be obtained according to a difference between the first result and the reference result, the second degree of opening of the vent VT in the second mode may be obtained according to a difference between the second result and the reference result or a difference between the second result and the first result, and the third degree of opening of the vent VT in the third mode may be obtained according to a difference between the third result and the reference result, but not limited thereto.

For example, according to above, if the venting device VD has the vent VT which is closed and opened well, in the condition that the sound source 120 generates the sound wave with one suitable frequency (e.g., 100 Hz), the first difference of the sensed sound pressure levels (related to the first result and the reference result), the second difference of the sensed sound pressure levels (related to the second result and the reference result or related to the second result and the first result) and the third difference of the sensed sound pressure levels (related to the third result and the reference result) would respectively meet the above ranges.

Therefore, users may use the measuring system 100 and the measuring method of the present invention to test the venting device VD, so as to identify whether the venting device VD is good or not.

The measuring system and the measuring method of the present invention are not limited by the above embodiments. Other embodiments of the present invention are described below. For ease of comparison, same components will be labeled with the same symbol in the following. The following descriptions relate the differences between each of the embodiments, and repeated parts will not be redundantly described.

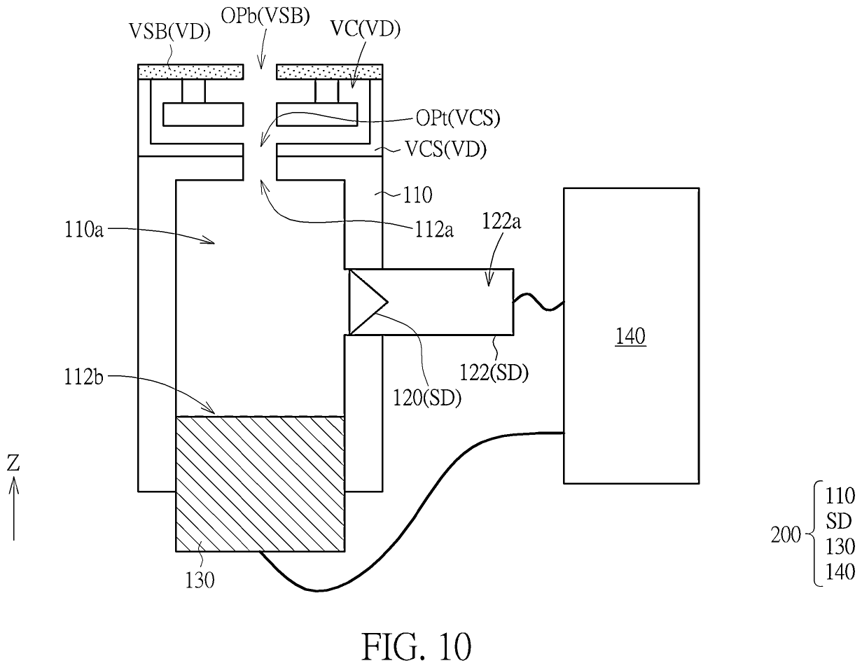

Referring to FIG. 10, FIG. 10 is a schematic diagram illustrating a measuring system according to a second embodiment of the present invention. Comparing with the first embodiment, in the measuring system 200 shown in FIG. 10, the venting component VC is upside down. For example, in FIG. 10, the venting device VD is upside down, but not limited thereto. In the embodiment of FIG. 10, in order to make the conductive pad BP of the substrate VSB be electrically connected to (e.g., be directly in contact with) the conductive structure 152 of the top cover 150, the conductive pad BP may be disposed on a side of the substrate VSB opposite to the covering structure VCS and the venting component VC.

In another case (not shown in figures), the venting component VC may be disposed in the venting device VD by a flip chip manner, so as to make the venting component VC upside down, but not limited thereto.

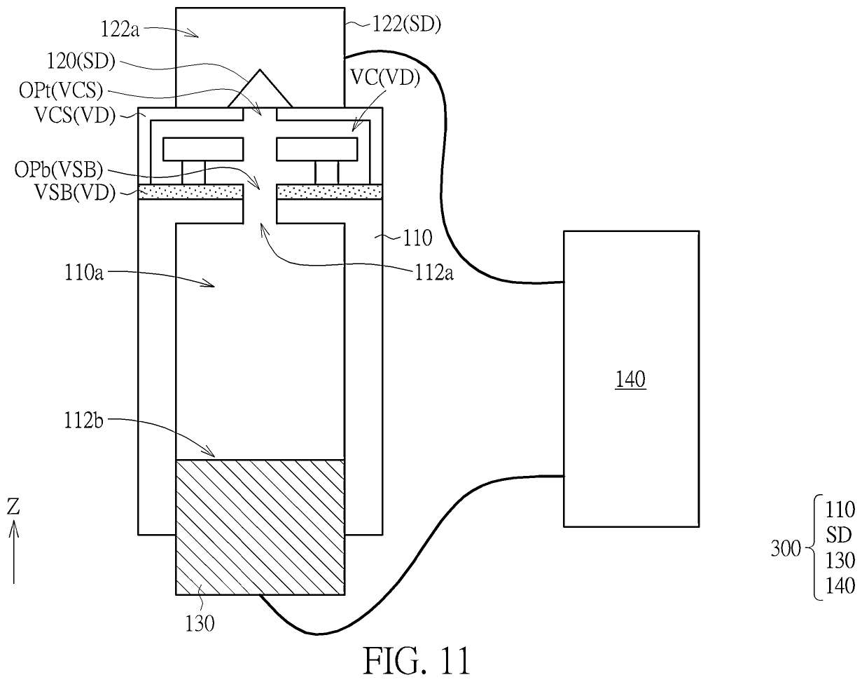

Referring to FIG. 11, FIG. 11 is a schematic diagram illustrating a measuring system according to a third embodiment of the present invention, wherein a structure shown in FIG. 11 is a second basic framework of a measuring system 300 of a third embodiment of the present invention, and the measuring system 300 of the third embodiment of the present invention may be achieved in any suitable way according to the second basic framework. Comparing with the first embodiment, in the measuring system 300 shown in FIG. 11, the position of the sound generating device SD (the sound source 120 and the second chamber 122) is changed. In FIG. 11, the sound generating device SD is disposed on the device under test (e.g., the venting device VD), such that the device under test (e.g., the venting device VD) is disposed between the first chamber 110 and the sound source 120, the sound source 120 is disposed between the venting device VD and the second chamber 122, and the sound source 120 and the device under test (e.g., the venting device VD) are connected to the first cavity 110a of the first chamber 110 and the second cavity 122a of the second chamber 122.

In the second basic framework of the measuring system 300, the relation between the top cover 150 and the sound generating device SD may be designed based on requirement(s), wherein the top cover 150 is not shown in FIG. 10. In some embodiments, the sound source 120 and the second chamber 122 may be disposed on the top cover 150, and the sound source 120 may be connected to the air channel 154 of the top cover 150, such that the top cover 150 may be disposed between the sound source 120 and the device under test (e.g., the venting device VD), and the first cavity 110a of the first chamber 110 may be connected to the sound source 120 through the air channel 154 and the venting device VD, but not limited thereto.

In some embodiments, the sound source 120 and the second chamber 122 may be disposed in the top cover 150, and the aforementioned air channel 154 may be removed from the top cover 150, but not limited thereto. In some embodiments, the sound source 120, the second chamber 122 and the top cover 150 may be combined to be one structure, but not limited thereto.

In the measuring system 300 shown in FIG. 11, the device under test (e.g., the venting device VD) is disposed between the sound source 120 and the sound sensing device 130, such that the sound wave generated by the sound source 120 needs to pass through the device under test to propagate towards the first cavity 110a of the first chamber 110. Therefore, because of the air leakage and/or the sound leakage, the degree of opening of the device under test is related to the sound (e.g., the sound pressure level of the sound) in the first cavity 110a of the first chamber 110. For example, the sound pressure level of the sound in the first cavity 110a of the first chamber 110 is increased as the degree of opening of the device under test in increased.

For instance, the sound source 120 may generate a sound wave with one suitable frequency, and the sound sensing device 130 may sense the sound pressure level of the sound in the first cavity 110a, such that the degree of opening of the device under test may be known by measuring the sound pressure level of the sound in the first cavity 110a. For example, the frequency of the sound wave may be approximately 100 Hz, but not limited thereto.

Since the reference device RD is a fully sealed device, the reference device RD would almost never cause the air leakage and the sound leakage. Thus, the sensed sound pressure level in the reference result of the reference measuring process measuring the reference device RD is less than the sensed sound pressure level in the condition of measuring the venting device VD in each mode. According to the degrees of opening of the vent VT formed by the venting device VD in each mode, the sensed sound pressure level in the first result of the first measuring process measuring the venting device VD in the first mode is less than the sensed sound pressure level in the third result of the third measuring process measuring the venting device VD in the third mode, and the sensed sound pressure level in the third result is less than the sensed sound pressure level in the second result of the second measuring process measuring the venting device VD in the second mode.

A difference between the result of measuring the venting device VD and the reference result of measuring the reference device RD is decreased as a difference of the degree of opening of the vent VT formed by the venting device VD and the degree of opening of the reference device RD is decreased. Namely, the venting device VD is designed to achieve that a difference between the result of measuring the venting device VD and the reference result of measuring the reference device RD is extremely small (e.g., this difference is smaller than a specific small value) if the vent VT of the venting device VD is closed, and the venting device VD is designed to achieve that a difference between the result of measuring the venting device VD and the reference result of measuring the reference device RD is large (e.g., this difference is greater than a specific large value) if the vent VT of the venting device VD is opened.

A first difference between the sensed sound pressure level in the first result (i.e., the first mode) and the sensed sound pressure level in the reference result may be less than or equal to a first value. For example, the first value may be 1 dB, such that the first difference may range from 0 dB to 1 dB, but not limited thereto.

A second difference may be between the sensed sound pressure level in the second result (i.e., the second mode) and the sensed sound pressure level in the reference result or may be between the sensed sound pressure level in the second result (i.e., the second mode) and the sensed sound pressure level in the first result (i.e., the first mode), and the second difference may be greater than or equal to a second value, wherein the second value is greater than the first value. For example, the second value may be 20 dB (e.g., the second difference may range from 23 dB to 27 dB), but not limited thereto.

A third difference between the sensed sound pressure level in the third result (i.e., the third mode) and the sensed sound pressure level in the reference result may be a third value approximately or in a range of which the third value is an average, wherein the third value is between the first value and the second value, and a difference between the third value and the first value is less than a difference between the third value and the second value. In another embodiment, the venting device VD under the third mode is determined to be normal when the third difference is less than or equal to the third value. For example, the third value may be 5 dB (e.g., the third difference may range from 3 dB to 7 dB), but not limited thereto.

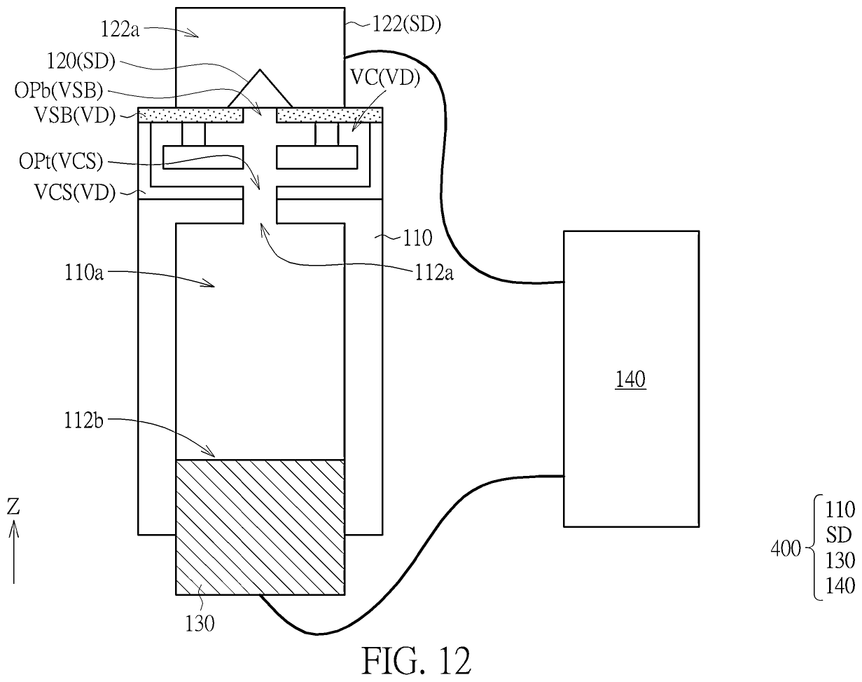

Referring to FIG. 12, FIG. 12 is a schematic diagram illustrating a measuring system according to a fourth embodiment of the present invention. Comparing with the third embodiment, in the measuring system 400 shown in FIG. 12, the venting component VC is upside down. For example, in FIG. 12, the venting device VD is upside down, and the conductive pad BP may be disposed on a side of the substrate VSB opposite to the covering structure VCS and the venting component VC, but not limited thereto. For example (not shown in figures), the venting component VC may be disposed in the venting device VD by a flip chip manner, so as to make the venting component VC upside down, but not limited thereto.

In summary, the users may use the measuring system and the measuring method of the present invention to test the venting device, so as to identify whether the venting device is good or not.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A measuring system, comprising:
a first chamber, wherein a first cavity exists inside the first chamber;
a sound sensing device configured to sense a sound in the first cavity;
a sound source configured to generate a sound wave propagating towards the first cavity; and
a top cover disposed on the first chamber;
wherein the measuring system is configured to measure a degree of opening of a vent formed by a venting device;
wherein the venting device is disposed between the first chamber and the top cover and connected to the first cavity of the first chamber for being measured the degree of opening, the first cavity of the first chamber is between the venting device and the sound sensing device, and the degree of opening is obtained according to a result generated by the sound sensing device.

2. The measuring system of claim 1, wherein the venting device has a first mode and a second mode, the vent of the venting device in the first mode has a first size, the vent of the venting device in the second mode has a second size, and the first size is different from the second size.

3. The measuring system of claim 1, wherein the sound sensing device faces the venting device.

4. The measuring system of claim 1, wherein the sound source is disposed between the venting device and the sound sensing device.

5. The measuring system of claim 1, wherein the venting device is disposed between the first chamber and the sound source.

6. The measuring system of claim 5, further comprising a second chamber, wherein a second cavity exists inside the second chamber, the sound source is disposed between the venting device and the second chamber, and the sound source is connected to the second cavity of the second chamber.

7. The measuring system of claim 1, wherein the top cover has an air channel connected to the first cavity of the first chamber through the venting device.

8. The measuring system of claim 7, wherein the first cavity of the first chamber is connected to an outer space of the measuring system through the air channel and the venting device.

9. The measuring system of claim 1, wherein the top cover comprises a conductive structure electrically connected to the venting device.

10. The measuring system of claim 1, further comprising a position changing structure configured to bring the first chamber and the top cover close to each other.

11. The measuring system of claim 1, further comprising a mode changing device configured to control a mode of the venting device.

12. The measuring system of claim 1, further comprising a signal processing device electrically connected to the sound sensing device, wherein the signal processing device is configured to receive and analyze a sensing signal generated by the sound sensing device.

13. The measuring system of claim 1, wherein the first chamber is a tubular structure.

14. A measuring method, comprising:
providing a measuring system, wherein the measuring system comprises:
a first chamber, wherein a first cavity exists inside the first chamber;
a sound source configured to generate a sound wave propagating towards the first cavity; and
a top cover disposed on the first chamber; and
performing a first measuring process on a venting device, wherein the first measuring process comprises:
disposing the venting device between the first chamber and the top cover; and
sensing a first sound in the first cavity of the first chamber when generating the sound wave by the sound source, wherein a first degree of opening of a vent formed by the venting device is obtained according to a first result related to the first sound.

15. The measuring method of claim 14, further comprising:
performing a reference measuring process on a reference device, wherein the reference measuring process comprises:
disposing the reference device between the first chamber and the top cover; and
sensing a reference sound in the first cavity of the first chamber when generating the sound wave by the sound source, wherein the first degree of opening of the vent formed by the venting device is obtained according to the first result related to the first sound and a reference result related to the reference sound.

16. The measuring method of claim 15, wherein the reference device is a fully sealed device.

17. The measuring method of claim 14, wherein the first measuring process is performed on the venting device in a first mode, and the measuring method further comprises:
performing a second measuring process on the venting device in a second mode, wherein the second measuring process comprises:
disposing the venting device in the second mode between the first chamber and the top cover; and
sensing a second sound in the first cavity of the first chamber when generating the sound wave by the sound source, wherein a second degree of opening of the vent formed by the venting device in the second mode is obtained according to a second result related to the second sound.

18. The measuring method of claim 17, wherein the vent of the venting device in the first mode has a first size, the vent of the venting device in the second mode has a second size, and the first size is different from the second size.

19. The measuring method of claim 14, wherein the measuring system further comprises a sound sensing device configured to sense the first sound.

20. A testing method of testing a venting device, comprising:
obtaining a reference result;
obtaining a first result corresponding to a first mode of the venting device and a second result corresponding to a second mode of the venting device;
obtaining a first difference between the first result and the reference result and a second difference between the second result and the reference result;
determining the venting device under the first mode being normal when the first difference is less than a first value; and
determining the venting device under the second mode being normal when the second difference is greater than a second value;
wherein the venting device is driven to operate in the first mode or the second mode;
wherein the second value is larger than the first value.

21. The testing method of claim 20, comprising:
obtaining a third result corresponding to a third mode of the venting device;
obtaining a third difference between the third result and the reference result;
determining the venting device under the third mode being normal when the third difference is less than a third value;
wherein the third value is greater than the first value.
